(19) United States
(12) Patent Application Publication
(10) Pub. No.: US 2017/0240091 A1
(43) Pub. Date: Aug. 24, 2017

(54) TRAILER-BASED CONSTRUCTION PLATFORM

(71) Applicant: Brockport Trailers Corp., Etobicoke (CA)

(72) Inventors: Tad Putyra, Toronto (CA); Eugene Christopher Filice, Milton (CA); Kamal Sabaratnam, Oakville (CA); John Carl Csiki, Keswick (CA); Armindo Pinheiro, Toronto (CA); David Rubino, Etobicoke (CA)

(21) Appl. No.: 15/048,568

(22) Filed: Feb. 19, 2016

(51) Int. Cl. B60P 3/40

(52) U.S. Cl. CPC B60P 3/40

(57) ABSTRACT

A support tube end element provides a structure allowing support of trailer platform support tubes to form expansive, stable base useful in house construction. Additionally, the support tube end element has a feature allowing for jack support of a platform support tube on the periphery of the base. A trailer for forming the base includes a frame, a plurality of stationary platform support tubes and a plurality of moveable platform support tubes received, at a first end, within the plurality of stationary platform support tubes. Each moveable platform support tube has, at a second end, the support tube end element. A construction method involves moving the trailer to a job site, extending the moveable platform support tubes, affixing a jack post to the support tube end element and extending the jack post to contact a substrate such that the jack post supports the moveable platform support tube.

### FIELD

The present application relates generally to house construction and, more specifically, to a trailer-based construction platform.

### BACKGROUND

In house building, it is increasingly the case that various parts of a house may be assembled in a sheltered manufacturing facility before being loaded, as cargo, onto a truck and shipped to the building site. However, some parts are not suitable for such pre-assembly and shipping, or can only be pre-assembled to a certain extent.

### BRIEF DESCRIPTION OF THE DRAWINGS

Reference will now be made, by way of example, to the accompanying drawings which show example implementations; and in which:

FIG. 1 illustrates, in a side view, a dual axle trailer frame with adjustable rear axle position;

FIG. 2 illustrates, in a plan view, the dual axle trailer frame of FIG. 1;

FIG. 3 illustrates, in a side view, the dual axle trailer frame of FIG. 1;

FIG. 4 illustrates, in a plan view, a pair of dual axle trailers arranged side-by-side to form a construction base to construct larger roof sections;

FIG. 5 illustrates, in front view, the pair of dual axle trailers of FIG. 4;

FIG. 6 illustrates, in a plan view, a pair of dual axle trailers arranged side-by-side to form a construction platform with movable platform support tubes extended to a greater extent than in FIG. 4;

FIG. 7 illustrates, in front view, the pair of dual axle trailers of FIG. 6;

FIG. 8 illustrates adjacent support tubes from distinct trailers, featuring end elements;

FIG. 9 illustrates the end element of FIG. 8 in isolation in a left-rear perspective view; and

FIG. 10 illustrates the end element of FIG. 8 in isolation in a left-front perspective view.

### DETAILED DESCRIPTION

While roof trusses, themselves, may be suitable for pre-assembly and shipping in the manner that other house parts may also be, there may be advantages to further assembly of a roof from the roof trusses before adding the further assembled roof to an under-construction house. However, house construction sites may not have a suitable area for such further assembly. In addition, the pre-assembled roof sections may not be suitable for highway transportation due to the size restrictions. Conveniently, one or more flat trailers may be positioned in such a manner to provide a suitable platform for roof pre-assembly.

According to an aspect of the present disclosure, there is provided a support tube end element comprising a first plate, a second plate, a bridge plate connecting the first plate to the second plate in a manner such that the first plate is maintained generally parallel to the second plate and a jack connection post fastened to the bridge plate, the selected plate being one of the first plate, the second plate and the bridge plate, the jack connection post extending away from the selected plate in an orientation that is generally perpendicular to a plane defined by the selected plate.

According to another aspect of the present disclosure, there is provided a trailer. The trailer includes a frame, a plurality of stationary platform support tubes, a plurality of moveable platform support tubes received, at a first end, within the plurality of stationary platform support tubes. Each moveable platform support tube, of the plurality of moveable platform support tubes, has, at a second end, a support tube end element. The support tube end element including a first plate, a second plate, a bridge plate connecting the first plate to the second plate in a manner such that the first plate is maintained generally parallel to the second plate, the bridge plate fastened to each moveable platform support tube and a jack connection post fastened to a selected plate, the selected plate being one of the first plate, the second plate and the bridge plate, the jack connection post extending away from the selected plate in an orientation that is generally perpendicular to a plane defined by the selected plate.

According to another aspect of the present disclosure, there is provided a construction method. The constructions method includes moving a trailer to a job site. The trailer includes a frame, a plurality of stationary platform support tubes, a plurality of moveable platform support tubes received, at a first end, within the plurality of stationary platform support tubes and each moveable platform support tube, of the plurality of moveable platform support tubes, having, at a second end, a support tube end element. The constructions method further includes extending the plurality of moveable platform support tubes, affixing a jack post to the support tube end element and extending the jack post to contact a substrate such that the jack post supports the moveable platform support tube.

Other aspects and features of the present disclosure will become apparent to those of ordinary skill in the art upon review of the following description of specific implementations of the disclosure in conjunction with the accompanying figures.

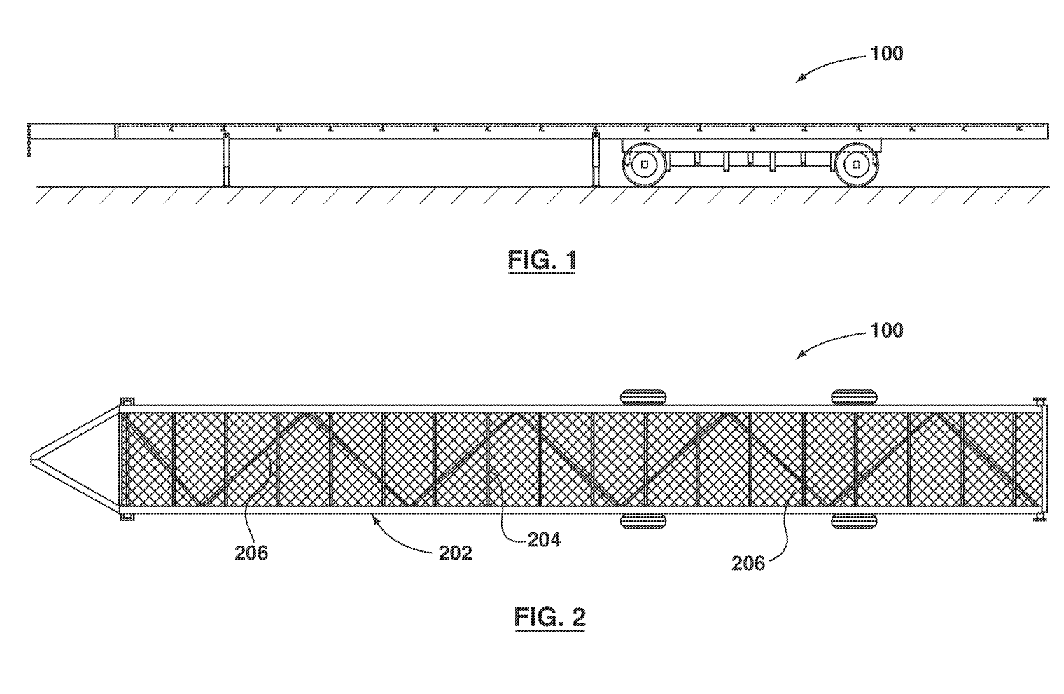

FIG. 1 illustrates, in a side view, a dual axle trailer frame 100. FIG. 2 illustrates, in a plan view, the dual axle trailer frame 100 of FIG. 1. The dual axle trailer frame 100 may be formed, in part, from two I-beam frame rails 202. Spanning a separation between the I-beam frame rails 202 are multiple cross ribs 204, positioned perpendicular to the I-beam frame rails 202. Additional structural strength is provided by multiple cross bracing members 206. In general, a cross bracing member 206 attaches, on one end, to an I-beam frame rail 202 mid-way between where two cross ribs 204 attach to one of the I-beam frame rails 202 and attaches, on the other end, to another I-beam frame rail 202 between where two cross ribs 204 attach to the other one of the I-beam frame rails 202.

As will be appreciated, the trailer frame 100 is shown with two axles for illustration purposes and incentive may exist for a trailer frame with one axle or three or more axles dependent upon the situation.

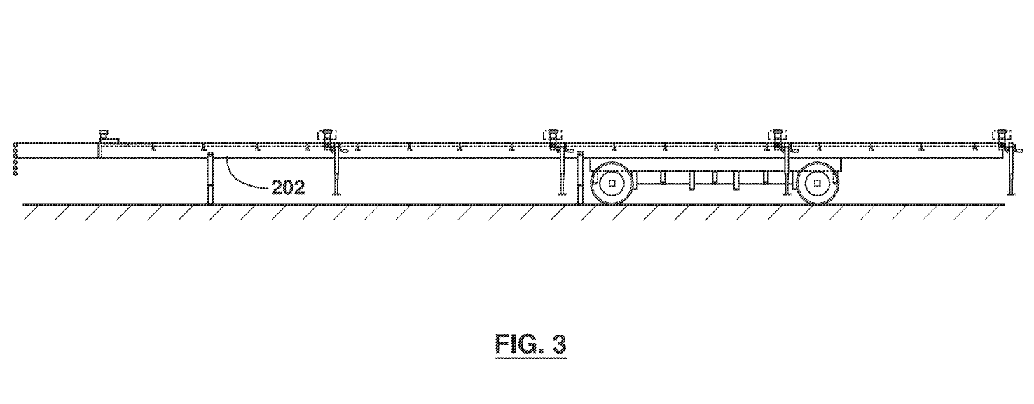

FIG. 3 illustrates, in a side view, the dual axle trailer frame of FIG. 1.

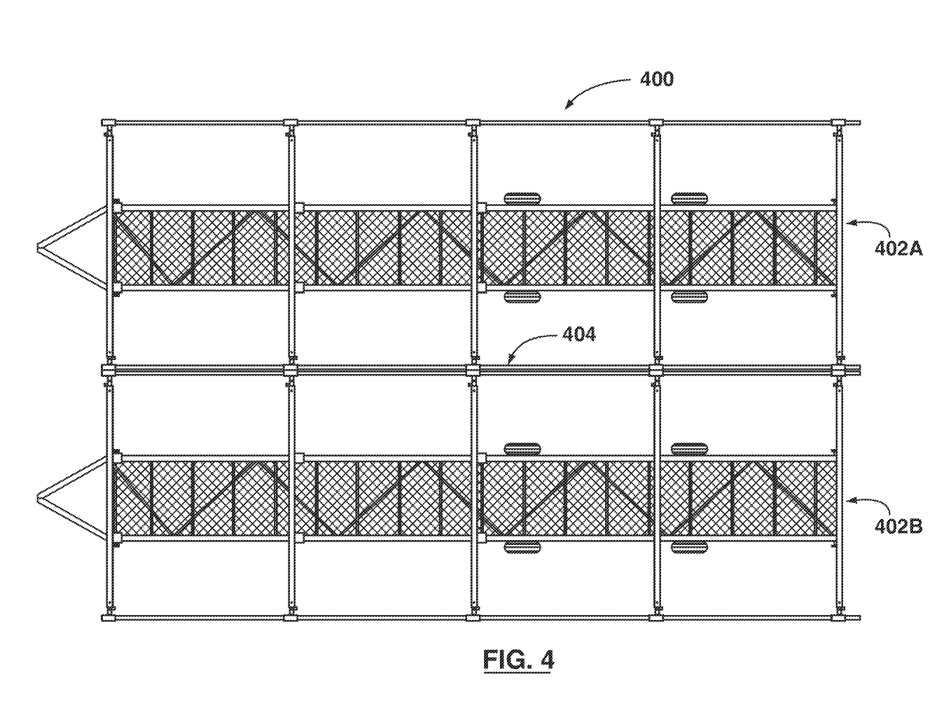

FIG. 4 illustrates, in a plan view, a first dual axle trailer 402A and a second dual axle trailer 402B arranged side-by-side to form a first base 400 for a construction platform having a seam 404.

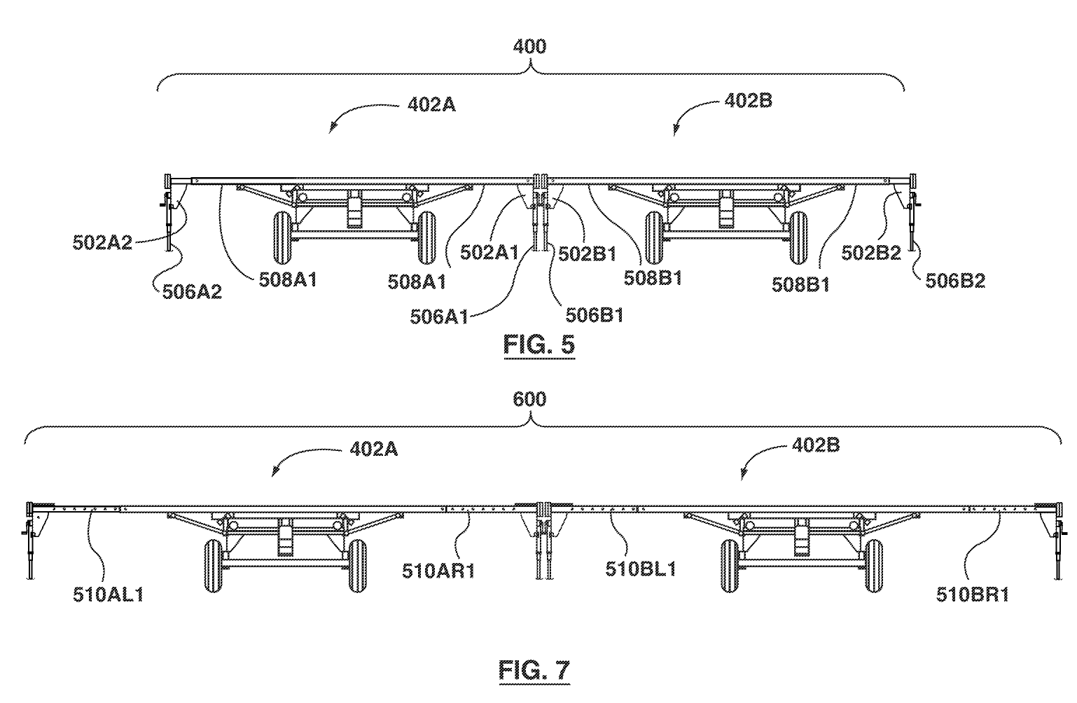

FIG. 5 illustrates, in front view, the first dual axle trailer 402A and the second dual axle trailer 402B arranged to form the first base 400 for the construction platform.

The adjacent portions of the trailers 402A, 402B feature a first support tube end element 502A1 and a second support tube end element 50261. The support tube end elements may be referred to collectively or individually using reference numeral 502. Indeed, though not illustrated in FIG. 5, multiple sets of support tube end elements may be used along the seam 404 formed between the trailers 402A, 402B.

As viewed in FIG. 5, support for the right side of the left-hand dual axle trailer 402A is accomplished, in part, by a connection between the first support tube end element 502A1 and a first jack post 506A1. Similarly, support for the right side of the right-hand dual axle trailer 402B is accomplished, in part, by a connection between the second support tube end element 50262 and a second jack post 506B2.

As viewed in FIG. 5, support for the left side of the left-hand dual axle trailer 402A is accomplished, in part, by a connection between a third support tube end element 502A2 and a third jack post 506A2. Similarly, support for the left side of the right-hand dual axle trailer 402B is accomplished, in part, by a connection between a fourth support tube end element 502B1 and a fourth jack post 506B1.

The front view of FIG. 5 exposes, on the first dual axle trailer 402A, a first stationary platform tube 508A1 and, on the second dual axle trailer 402B, a second stationary platform tube 508B1.

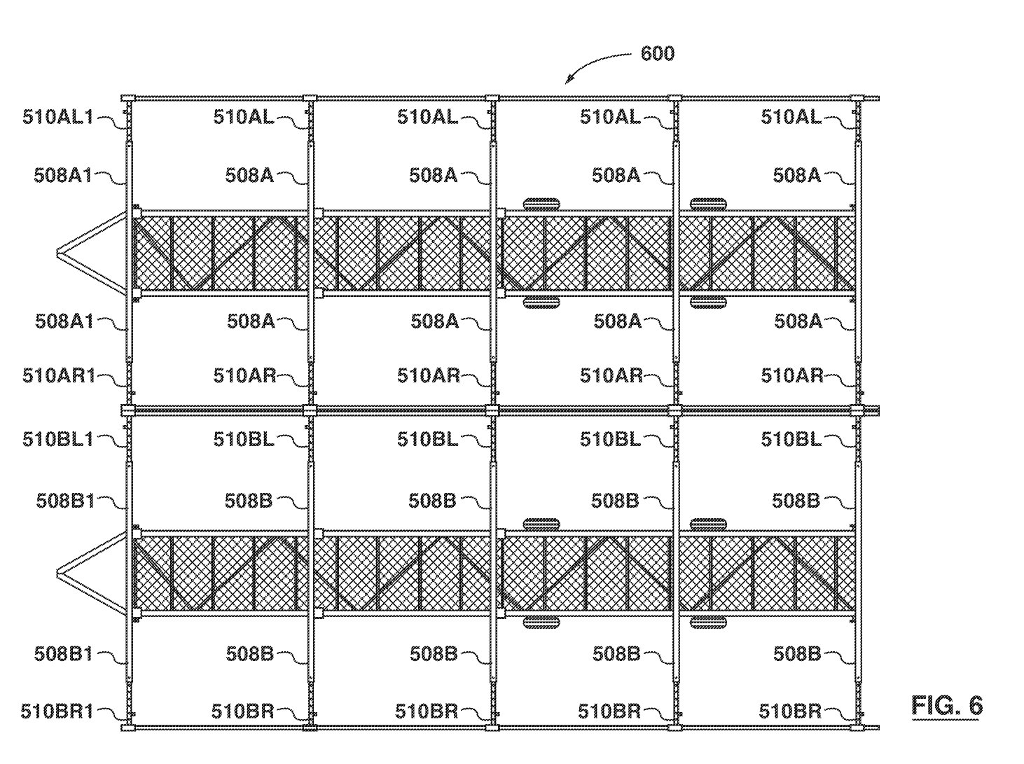

FIG. 6 illustrates, in a plan view, the dual axle trailers 402A, 402B of FIG. 4. The trailers 402A, 402B are arranged side-by-side to form a second base 600 for a construction platform. The second base 600 is configured in a manner that uses extended moveable platform tubes to expand the overall area of the second base 600 to be greater than the overall area of the first base 400 in FIG. 4.

FIG. 7 illustrates, in front view, the pair of dual axle trailers 402A, 402B in the configuration of FIG. 6. The front view of FIG. 7 exposes, on the first dual axle trailer 402A, a first-right moveable platform support tube 510AR1 and a first-left moveable platform support tube 510AL1 and, on the second dual axle trailer 402B, a second-right moveable platform support tube 510BR1 and a second-left moveable platform support tube 510BL1.

In further view of FIGS. 5 and 7, the first-right moveable platform support tube 510AR1 extends from within the first stationary platform tube 508A1. The first-left moveable platform support tube 510AL1 extends from within the first stationary platform tube 508A1. The second-right moveable platform support tube 510BR1 extends from within the second stationary platform tube 508B1. The second-left moveable platform support tube 510BL1 extends from within the second stationary platform tube 508B1.

Indeed, though not illustrated in FIG. 7, both dual axle trailers 402A, 402B include multiple moveable platform tubes extendable from multiple stationary platform tubes. As illustrated in FIG. 6, the first dual axle trailer 402A may have multiple stationary platform tubes. The stationary platform tubes on the first dual axle trailer 402A may be referred to collectively or individually using reference numeral 508A. Similarly, as illustrated in FIG. 6, the second dual axle trailer 402B may have multiple stationary platform tubes. The stationary platform tubes on the second dual axle trailer 402B may be referred to collectively or individually using reference numeral 508B.

As illustrated in FIG. 6, the first dual axle trailer 402A may have multiple right moveable platform tubes and left moveable platform tubes. The left moveable platform tubes on the first dual axle trailer 402A may be referred to collectively or individually using reference numeral 510AL. The right moveable platform tubes on the first dual axle trailer 402A may be referred to collectively or individually using reference numeral 510AR. Similarly, as illustrated in FIG. 6, the second dual axle trailer 402B may have multiple right moveable platform tubes and left moveable platform tubes. The left moveable platform tubes on the second dual axle trailer 402B may be referred to collectively or individually using reference numeral 510BL. The right moveable platform tubes on the second dual axle trailer 402B may be referred to collectively or individually using reference numeral 510BR.

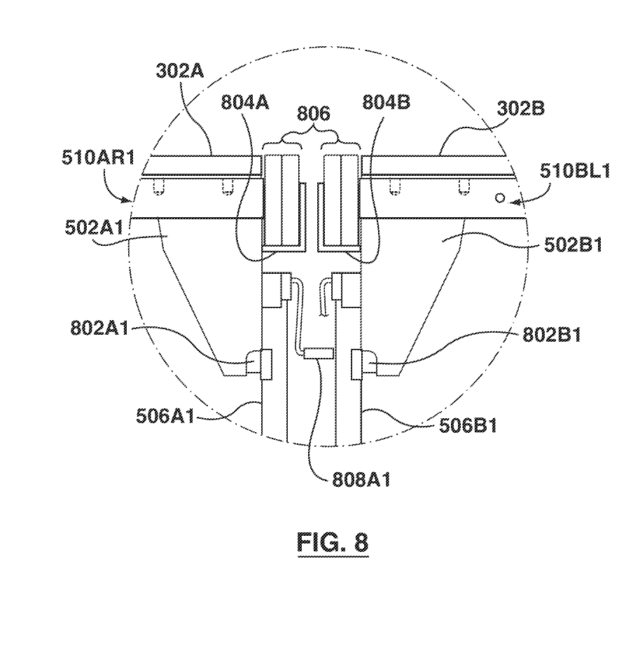

FIG. 8 illustrates the support tube end elements 502A1, 502B1 used, as illustrated in FIGS. 5 and 7 and in conjunction with the first jack post 506A1 and the second jack post 50661, as support along the seam 404 (see FIG. 4) formed between the trailers 402A, 402B.

Elements of the first support tube end element 502A1 that are identified in FIG. 8 include a first L-bracket 804A. Similarly, the second support tube end element 502B1 includes a second L-bracket 804B. Each of the L-brackets 804 is sized to, in conjunction with an end of a moveable platform support tube 510, form a channel to accommodate a pair of, for example, two-by-eight planks, generally indicated by reference numeral 806.

Also indicated in FIG. 8 are a first platform board 302A and a second platform board 302B. The platform boards 302 may, for example, be two-by-six boards. The first platform board 302A may be mounted on the top of the first-right moveable platform support tube 510AR1 to provide a wooden surface. The second platform board 302B may be mounted on the top of the second-left moveable platform support tube 510BL1 to provide a wooden surface. The platform boards 302 may be mounted on two foot long steel plate sections (not shown). The steel plate sections may have pins attached to the underside for locating. These steel plate sections, with mounted platform boards 302, may be placed onto the movable platform support tubes 510 so that the pins are received by pre-drilled holes on the movable platform support tubes 510. Further platform boards (not shown in FIG. 8) may be attached to the stationary platform tubes 508 in a similar manner.

The planks 806 may be positioned in such a manner that the top sides of the two-by-eight planks 806 are generally co-planar with the top surface of the first platform board 302A and the second platform board 3026.

Elements of the first jack post 506A1 that are identified in FIG. 8 include a first jack mount collar 802A1 and a jack crank arm 808A1. Similarly, the second jack post 506B1 is illustrated as including a second jack mount collar 80261.

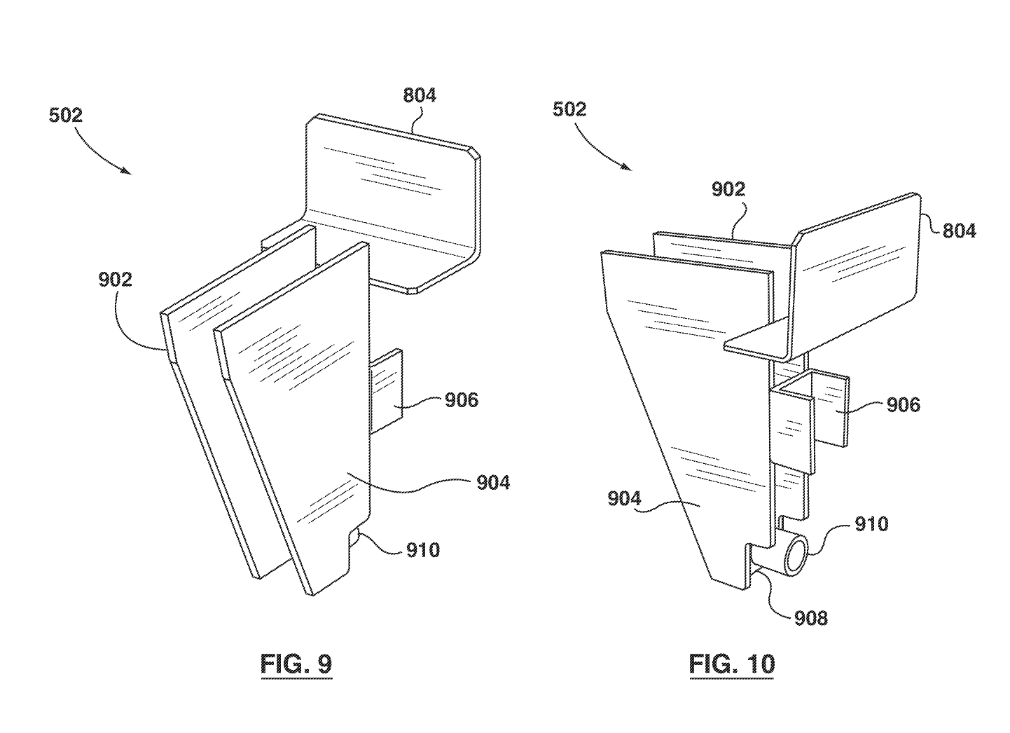

FIG. 9 illustrates the support tube end element 502 in isolation in a left-rear perspective view. The support tube end element 502 is formed of two parallel plates 902, 904 connected by a bridge plate 908 (see FIG. 10). The bridge plate 908 maintains a separation between the parallel plates 902, 904. A jack connection post 910 extends from the bridge plate 908 between the parallel plates 902, 904.

Although the jack connection post 910 is illustrated as a hollow, cylindrical tube, other shapes may be equally useful, including a hollow squared shape and a solid cylindrical shape.

FIG. 9 also illustrates the L-bracket 804 fastened to the two parallel plates 902, 904 in an orientation that is generally perpendicular to the plane defined by the two parallel plates 902, 904.

FIG. 10 illustrates the support tube end element 502 in isolation in a left-front perspective view.

In use, the support tube end element 502 may be fastened to the end of the moveable platform support tube 510 by specifically fastening each of the two parallel plates 902, 904 to the moveable platform support tube 510. In general, both the moveable platform support tube 510 and the support tube end element 502 may be fabricated of steel and may be welded, bolted or riveted together, among other fastening means.

In operation, the first dual axle trailer 402A may be towed into position by a suitable vehicle and, if deemed necessary, detached from the vehicle. Subsequently, the first-right moveable platform support tube 510AR1 may be extended from within the first stationary platform tube 508A1. Once the first-right moveable platform support tube 510AR1 has been extended to a desired distance, a jack connection post 910 of the first support tube end element 502A1 may be inserted into the jack mount collar 802A1 of the first jack post 506A1. A user may rotate the crank arm 808A1 to extend the first jack post 506A1 to span a distance between the first support tube end element 502A1 and the ground, thereby providing support, via the first support tube end element 502A1, for the first-right moveable platform support tube 510AR1.

Similar actions may then be carried out in respect of a plurality of further right moveable platform support tubes 510AR.

In single trailer operation, the first-left moveable platform support tube 510AL1 may be extended from within the first stationary platform tube 508A1 and connected, for support via the third support tube end element 502A2, to the third jack post 506A2. Similar actions may then be carried out in respect of a plurality of further left moveable platform support tubes 510AL.

For dual trailer operation, for forming the first base 400 or second base 600 as illustrated in FIGS. 4, 5, 6 and 7, the second dual axle trailer 4026 may be towed into position, beside the first dual axle trailer 402A, by a suitable vehicle and, if deemed necessary, detached from the vehicle. Subsequently, the second-right moveable platform support tube 5106R1 may be extended from within the second stationary platform tube 508B1. Once the second-right moveable platform support tube 5106R1 has been extended a desired distance, a jack connection post 910 of the fourth support tube end element 50262 may be inserted into a jack mount collar 802 of the fourth jack post 50662. A user may extend the second jack post 5066 to span a distance between the fourth support tube end element 50262 and the ground, thereby providing support, via the fourth support tube end element 50262, for the second-right moveable platform support tube 5106R1.

Similar actions may then be carried out in respect of a plurality of further right moveable platform support tubes 5106R.

Additionally, the second-left moveable platform support tube 510BL1 may be extended, from within the second stationary platform tube 508B1, toward the first dual axle trailer 402A.

Once the moveable platform support tubes have been extended and supported by jack posts on the outsides (510AL, 510BR) and insides (510AR, 510BL), a plurality of two-by-eight planks 806 may be received by the channels formed, in part, by the L-brackets 804 of all of the support tube end elements. Subsequently, the platform boards 302 may be laid down over the moveable platform support tubes 510 and further platform boards (not shown) may be laid down over the first stationary platform tubes 508. Building on the base 400/600 may then commence.

In sum, then, use of the trailer-based construction platform involves moving the trailer to a job site, the trailer including the trailer frame 100, the plurality of stationary platform support tubes 508, the plurality of moveable platform support tubes 510 received, at a first end, within the plurality of stationary platform support tubes 508, each moveable platform support tube 510 having, at a second end, the support tube end element 502. Use of the trailer-based construction platform further involves extending the plurality of moveable platform support tubes 510, affixing the jack post 506 to the support tube end element 502 and extending the jack post 506 to contact a substrate (such as the ground around the trailer) such that the jack post 506 supports the moveable platform support tube 510.

Notably, while the above has focused on an embodiment in which the support tube end element 502 is fastened at the end of a moveable platform support tube 510, in a case wherein the size of platform defined by a given trailer is not adjustable, the support tube end element 502 may be fastened to the stationary platform support tubes 508.

The above-described implementations of the present application are intended to be examples only. Alterations, modifications and variations may be effected to the particular implementations by those skilled in the art without departing from the scope of the application, which is defined by the claims appended hereto.

What is claimed is:

1. A support tube end element comprising:
a first plate;
a second plate;
a bridge plate connecting said first plate to said second plate in a manner such that said first plate is maintained generally parallel to said second plate; and
a jack connection post fastened to a selected plate, said selected plate being one of said first plate, said second plate and said bridge plate, said jack connection post extending away from said selected plate in an orientation that is generally perpendicular to a plane defined by said selected plate.

2. The support tube end element of claim 1 further comprising a L-bracket fastened to said first plate and said second plate in an orientation that is generally perpendicular to a plane defined by said first plate.

3. The support tube end element of claim 1 further comprising a platform support tube fastened to said bridge plate at one end of said platform support tube, said platform support tube adapted for moveable insertion within a stationary platform support tube.

4. The support tube end element of claim 1 further comprising a platform support tube fastened to said first plate and said second plate at one end of said platform support tube, said platform support tube adapted for moveable insertion within a stationary platform support tube.

5. The support tube end element of claim 1 wherein said selected plate comprises said bridge plate.

6. The support tube end element of claim 5 wherein jack connection post extends from between said first plate and said second plate.

7. A trailer comprising:
a frame;
a plurality of stationary platform support tubes;
a plurality of moveable platform support tubes received, at a first end, within said plurality of stationary platform support tubes;
each moveable platform support tube, of said plurality of moveable platform support tubes, having, at a second end, a support tube end element, said support tube end element including:
a first plate;
a second plate;
a bridge plate connecting said first plate to said second plate in a manner such that said first plate is maintained generally parallel to said second plate; and
a jack connection post fastened to a selected plate, said selected plate being one of said first plate, said second plate and said bridge plate, said jack connection post extending away from said selected plate in an orientation that is generally perpendicular to a plane defined by said selected plate.

8. A construction method comprising:
moving a trailer to a job site, said trailer including:
a frame;
a plurality of stationary platform support tubes;
a plurality of moveable platform support tubes received, at a first end, within said plurality of stationary platform support tubes;
each moveable platform support tube, of said plurality of moveable platform support tubes, having, at a second end, a support tube end element;
extending said plurality of moveable platform support tubes;
affixing a jack post to said support tube end element; and
extending said jack post to contact a substrate such that said jack post supports said moveable platform support tube.

9. The construction method of claim 8 further comprising placing a plurality of platform boards on said plurality of stationary platform support tubes and said plurality of moveable platform support tubes.

10. The construction method of claim 9 further comprising initiating construction on said platform.
